(19) United States
(12) Patent Application Publication
(10) Pub. No.: US 2024/0145787 A1
(43) Pub. Date: May 2, 2024

(54) PROCESSING METHOD FOR BATTERY

(71) Applicant: Prime Planet Energy & Solutions, Inc., Tokyo (JP)

(72) Inventor: Yusuke ITOH, Kobe-shi (JP)

(21) Appl. No.: 18/476,314

(22) Filed: Sep. 28, 2023

(30) Foreign Application Priority Data
Nov. 1, 2022 (JP) 2022-175523

(51) Int. Cl. H01M 10/0587; H01M 50/103; H01M 50/15; H01M 50/186; H01M 50/645

(52) U.S. Cl. CPC H01M 10/0587; H01M 50/103; H01M 50/15; H01M 50/186; H01M 50/645; H01M 10/0525

(57) ABSTRACT

The present disclosure provides a processing method for a battery including an exterior body and an electrode body. The exterior body includes a case main body including a bottom wall, an opening that faces the bottom wall, and side walls that extend from the bottom wall to the opening, and a lid body that seals the opening of the case main body. This processing method includes a cutting step of, when a posture in which the lid body is positioned directly above in a vertical direction and the side walls extend along the vertical direction is defined as a normal posture, cutting the exterior body in a posture other than the normal posture along the opening.

### CROSS REFERENCE TO RELATED APPLICATION

This application claims the benefit of priority to Japanese Patent Application No. 2022-175523 filed on Nov. 1, 2022. The entire contents of this application are hereby incorporated herein by reference.

### BACKGROUND OF THE DISCLOSURE

### 1. Field

The present disclosure relates to a processing method for a battery.

### 2. Background

A battery typically includes an exterior body and an electrode body accommodated in the exterior body. The exterior body includes a case main body including a bottom wall, an opening that faces the bottom wall, and side walls that extend from the bottom wall to the opening, and a lid body that seals the opening of the case main body. The exterior body is unified in a manner that the lid body is joined (for example, joined by welding) to a periphery of the opening of the case main body.

In order to reduce wastes and use resources effectively, used batteries are conventionally collected and recycled. In regard to this, for example, Japanese Patent No. 7120578 describes that a part joined by welding between a case main body and a lid body is cut by end mill machining or laser irradiation, an electrode body is extracted from the case main body, and a valuable metal such as Ni or Co is collected as a resource.

### SUMMARY

According to examinations by the present inventor, however, when the exterior body is opened by the end mill machining or the laser irradiation, a foreign substance such as cutting trash is easily mixed into the case main body from a cutting opening surface if the exterior body is cut along the opening in a normal posture in which the lid body is positioned directly above in a vertical direction and the side walls extend along the vertical direction. As a result, the ignition due to short-circuiting between positive and negative electrodes of the electrode body may occur.

The present disclosure has been made in view of the above circumstances and a main object of the present disclosure is to provide a processing method for a battery in which a foreign substance is not easily mixed into a case main body when an exterior body is opened.

The present disclosure provides a processing method for a battery that includes an exterior body and an electrode body accommodated in the exterior body, and the exterior body includes: a case main body including a bottom wall, an opening that faces the bottom wall, and side walls that extend from the bottom wall to the opening; and a lid body that seals the opening of the case main body. The processing method includes a cutting step of, when a posture in which the lid body is positioned directly above in a vertical direction and the side walls extend along the vertical direction is defined as a normal posture, cutting the exterior body in a posture other than the normal posture along the opening.

In a conventional method in which the exterior body is cut in the normal posture, since a cutting opening surface faces directly upward, cutting trash is easily mixed into the case main body. By contrast, when the exterior body is cut along the opening in the posture other than the normal posture, mixing of a foreign substance such as cutting trash to the inside of the case main body from the cutting opening surface can be suppressed compared to the conventional method. As a result, short-circuiting between positive and negative electrodes can be suppressed and the risk of the ignition can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically showing a battery according to an embodiment;

FIG. 2 is a schematic longitudinal cross-sectional view taken along line II-II in FIG. 1;

FIG. 3 is a schematic view of the battery in a hole working step (step S3);

FIG. 4 is a schematic view of the battery in a drainage step (step S5);

FIGS. 5A to 5C are schematic views of the battery in a cutting step (step S6), in which FIG. 5A shows a first fallen posture, FIG. 5B shows a second fallen posture, and FIG. 5C shows an inversion posture;

FIG. 6 is a picture of a cutting device according to an example; and

FIG. 7 is a schematic view showing a cutting position in the cutting step (step S6).

### DETAILED DESCRIPTION OF THE PREFERRED EMBODIMENTS

Hereinafter, some preferred embodiments of a technique disclosed herein will be described with reference to the drawings. Meanwhile, matters other than those particularly mentioned in the present specification and necessary for implementing the present disclosure (for example, general configurations and manufacturing processes of a battery which do not characterize the present disclosure) can be ascertained as a design matter of one skilled in the art based on the conventional art in the relevant field. The present disclosure can be implemented on the basis of the disclosure of the present specification and common technical knowledge in the relevant field.

Note that in the present specification, “battery” is a term that refers to a general power storage device that is capable of extracting electric energy, and refers to a concept encompassing a primary battery and a secondary battery. In addition, in the present specification, the term “secondary battery” refers to a general power storage device that is capable of being charged and discharged repeatedly, and refers to a concept encompassing a so-called storage battery (chemical battery) such as a lithium ion secondary battery, and a physical battery such as a lithium ion capacitor.

<Structure of Battery 100>

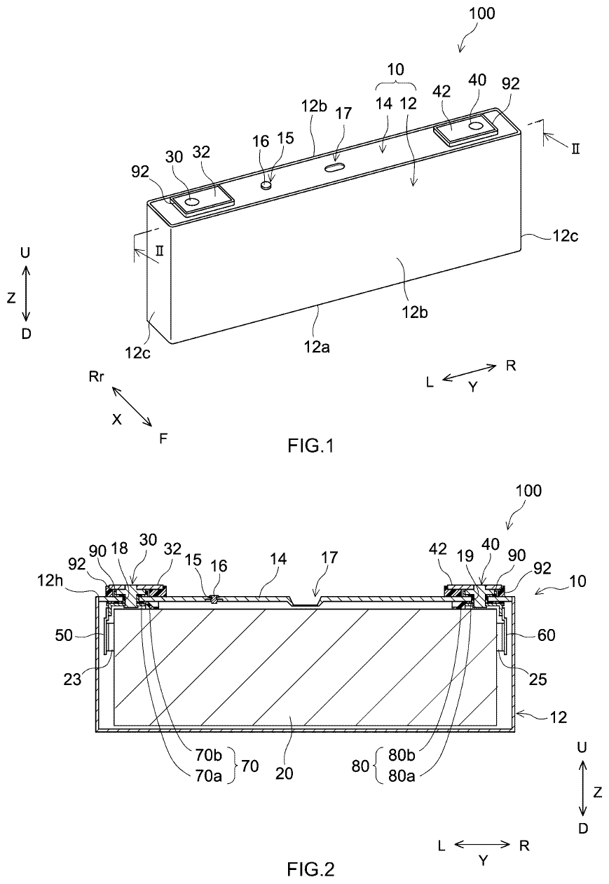

FIG. 1 is a perspective view of a battery 100 to be subjected to a process disclosed herein. FIG. 2 is a schematic longitudinal cross-sectional view taken along line II-II in FIG. 1. In the following description, reference signs L, R, F, Rr, U, and D in the drawings respectively denote left, right, front, rear, up, and down. In addition, reference signs X and Y in the drawings respectively denote a short side direction and a long side direction of the battery 100, and a reference sign Z denotes a vertical direction. Note that in the drawings below, the members and parts with the same operation are denoted by the same reference signs and the overlapping description may be omitted or simplified.

As shown in FIG. 2, the battery 100 includes an exterior body 10, a blind rivet 16, an electrode body 20, a positive electrode terminal 30, a negative electrode terminal 40, a positive electrode current collecting unit 50, a negative electrode current collecting unit 60, a positive electrode internal insulating member 70, and a negative electrode internal insulating member 80. Although not illustrated, the battery 100 in this case further includes an electrolyte solution. In this case, the battery 100 is a nonaqueous electrolyte secondary battery. Note that the structure of the battery 100 may be similar to that in the related art and is not particularly limited. In addition, the blind rivet 16, the positive electrode internal insulating member 70, and the negative electrode internal insulating member 80 are not always necessary, and can be omitted partially or entirely in another embodiment.

The exterior body 10 is a housing that accommodates the electrode body 20. As shown in FIG. 1, the external shape of the exterior body 10 is a flat and bottomed cuboid shape (rectangular shape) in this case. A conventionally used material can be used for the exterior body 10, without particular limitations. The exterior body 10 is preferably made of metal, and is formed of a metal material with small weight and high thermal conductivity, such as aluminum, an aluminum alloy, iron, or an iron alloy. In this case, the exterior body 10 is made of aluminum.

As shown in FIG. 2, the exterior body 10 includes a case main body 12 having an opening 12h, and a lid body (sealing plate) 14 that covers the opening 12h. The exterior body 10 is unified in a manner that the lid body 14 is joined (for example, joined by welding) to a periphery of the opening 12h of the case main body 12. Joining with the lid body 14 can be performed by welding such as laser welding. The opening 12h of the case main body 12 is hermetically covered (sealed).

As shown in FIG. 1, the case main body 12 includes a bottom wall 12a, a pair of long side walls 12b extending from the bottom wall 12a and facing each other, a pair of short side walls 12c extending from the bottom wall 12a and facing each other, and the opening 12h facing the bottom wall 12a (see FIG. 2). The short side wall 12c is smaller in area than the long side wall 12b. The bottom wall 12a and the opening 12h are substantially rectangular in shape. Note that in the present specification, “substantially rectangular shape” is a term encompassing, in addition to a perfect rectangular shape (rectangle), for example, a shape whose corner connecting a long side and a short side of the rectangular shape is rounded, a shape whose corner includes a notch, and the like. The long side wall 12b and the short side wall 12c are examples of a side wall extending from the bottom wall 12a to the opening 12h.

The lid body 14 is a plate-shaped member that seals the opening 12h of the case main body 12. As shown in FIG. 2, the lid body 14 is attached to the case main body 12 so as to cover the opening 12h. The lid body 14 is substantially rectangular in shape in a plan view. The lid body 14 is fitted to the opening 12h and faces the bottom wall 12a of the case main body 12. The lid body 14 is provided with a gas discharge valve 17, two terminal extraction holes 18 and 19, and a liquid injection hole 15.

The gas discharge valve 17 is configured to fracture when pressure inside the exterior body 10 reaches a predetermined value or more and discharge a gas in the exterior body 10 to the outside. The terminal extraction holes 18 and 19 are formed in both end parts of the lid body 14 in the long side direction Y. The terminal extraction holes 18 and 19 penetrate the lid body 14 in the vertical direction Z. The liquid injection hole 15 is a hole for injecting the electrolyte solution after the lid body 14 is assembled to the case main body 12. As shown in FIG. 2, the liquid injection hole 15 penetrates the lid body 14 in the vertical direction Z. The liquid injection hole 15 is sealed by the blind rivet 16. The liquid injection hole 15 is one example of a penetration hole provided to the lid body 14.

The blind rivet 16 is a member that covers the liquid injection hole 15 of the lid body 14. The blind rivet 16 is typically made of metal. The structure of the blind rivet 16 may be similar to the conventional structure thereof. The blind rivet 16 in this case includes an inserted part, a flange part, and an enlarged diameter part. The inserted part has a smaller outer diameter than the liquid injection hole 15, and is inserted into the liquid injection hole 15. The flange part extends upward from an upper end of the inserted part, and protrudes from the liquid injection hole 15 to the outside of the exterior body 10. The enlarged diameter part extends downward (toward an opposite side of the inserted part) from a lower end of the inserted part, and has a larger outer diameter than the liquid injection hole 15. The blind rivet 16 is fixed by caulking to the lid body 14 by the flange part and the enlarged diameter part. In the structure of the battery 100 including the blind rivet 16, a clearance is secured between the lid body 14 and the electrode body 20.

The electrode body 20 includes a positive electrode and a negative electrode. In this case, the electrode body 20 is a wound electrode body in which the positive electrode with a band shape and the negative electrode with a band shape are stacked via a separator with a band shape and wound using a winding axis as a center in the long side direction. The external shape of the electrode body 20 is a flat shape. However, the electrode body 20 may be a laminated electrode body in which a positive electrode with a square shape and a negative electrode with a square shape are laminated on each other in an insulated state. In this case, the wound electrode body 20 is accommodated inside the exterior body 10 so that the winding axis is substantially parallel to the long side direction Y. However, the wound electrode body 20 may be accommodated inside the exterior body 10 so that the winding axis is substantially parallel to the vertical direction Z. However, the number of electrode bodies 20 accommodated in the exterior body 10 may be one, or two or more (plural).

The positive electrode includes a positive electrode current collector and a positive electrode mixture layer fixed onto the positive electrode current collector. The positive electrode current collector is formed of a conductive metal such as aluminum, an aluminum alloy, nickel, or stainless steel. The positive electrode current collector in this case is made of aluminum. The positive electrode mixture layer typically contains a positive electrode active material (for example, a lithium transition metal complex oxide) capable of reversibly storing and releasing charge carriers, and a binder (for example, polyvinylidene fluoride (PVdF)).

The negative electrode includes a negative electrode current collector and a negative electrode mixture layer fixed onto the negative electrode current collector. The negative electrode current collector is formed of a conductive metal such as copper, a copper alloy, nickel, or stainless steel. The negative electrode current collector in this case is made of copper. The negative electrode mixture layer typically contains a negative electrode active material (for example, carbon material such as graphite) capable of reversibly storing and releasing charge carriers, and a binder (for example, styrene butadiene rubber (SBR) or carboxymethyl cellulose (CMC)).

At one end part (left end part in FIG. 2) of the electrode body 20 in the long side direction Y, a part of the positive electrode current collector (positive electrode tab 23) where the positive electrode mixture layer is not formed is exposed. To the positive electrode tab 23, a lower end part of the positive electrode current collecting unit 50 is connected. In addition, at the other end part (right end part in FIG. 2) of the electrode body 20 in the long side direction Y, a part of the negative electrode current collector (negative electrode tab 25) where the negative electrode mixture layer is not formed is exposed. To the negative electrode tab 25, a lower end part of the negative electrode current collecting unit 60 is connected.

In this case, the electrolyte solution is a nonaqueous liquid electrolyte (nonaqueous electrolyte solution) containing a nonaqueous solvent and a supporting salt. For example, the nonaqueous solvent includes carbonates such as ethylene carbonate (EC), dimethyl carbonate (DMC), and ethyl methyl carbonate (EMC). The supporting salt is, for example, a fluorine-containing lithium salt such as LiPF₆. However, the electrolyte solution may have a solid form (a solid electrolyte) to be integrated with the electrode body 20.

As shown in FIG. 1 and FIG. 2, the positive electrode terminal 30 is disposed at one end part of the lid body 14 in the long side direction Y (left end part in FIG. 1 and FIG. 2). As shown in FIG. 2, the positive electrode terminal 30 is electrically connected to the positive electrode of the electrode body 20 through the positive electrode current collecting unit 50 inside the exterior body 10. The positive electrode terminal 30 is inserted to the terminal extraction hole 18 and extends to the outside from the inside of the lid body 14. The positive electrode terminal 30 is formed of metal such as aluminum, an aluminum alloy, nickel, or stainless steel. In this case, the positive electrode terminal 30 is formed of aluminum. The positive electrode terminal 30 is insulated from the lid body 14 by the positive electrode internal insulating member 70 and a gasket 90.

A positive electrode external conductive member 32 with a plate shape is fixed on the positive electrode terminal 30. The positive electrode external conductive member 32 is a member that is connected to another battery or an external device via a bus bar or the like. The positive electrode external conductive member 32 is attached to the lid body 14 in a state of being insulated from the lid body 14 by an external insulating member 92. The positive electrode external conductive member 32 is formed of metal such as aluminum, an aluminum alloy, nickel, or stainless steel. In this case, the positive electrode external conductive member 32 is formed of aluminum.

As shown in FIG. 1 and FIG. 2, the negative electrode terminal 40 is disposed at the other end part of the lid body 14 in the long side direction Y (right end part in FIG. 1 and FIG. 2). As shown in FIG. 2, the negative electrode terminal 40 is electrically connected to the negative electrode of the electrode body 20 through the negative electrode current collecting unit 60 inside the exterior body 10. The negative electrode terminal 40 is inserted to the terminal extraction hole 19 and extends to the outside from the inside of the lid body 14. The negative electrode terminal 40 is formed of metal such as copper, a copper alloy, nickel, or stainless steel. In this case, the negative electrode terminal 40 is formed of copper. The negative electrode terminal 40 is insulated from the lid body 14 by the negative electrode internal insulating member 80 and the gasket 90.

A negative electrode external conductive member 42 with a plate shape is fixed on the negative electrode terminal 40. The negative electrode external conductive member 42 is a member that is connected to another battery or an external device via the bus bar or the like. The negative electrode external conductive member 42 is attached to the lid body 14 in a state of being insulated from the lid body 14 by the external insulating member 92. The negative electrode external conductive member 42 is formed of metal such as copper, a copper alloy, nickel, or stainless steel. In this case, the negative electrode external conductive member 42 is formed of copper.

The positive electrode current collecting unit 50 constitutes a conductive path that electrically connects the positive electrode tab 23 and the positive electrode terminal 30. The positive electrode current collecting unit 50 may be formed of the same metal species as the positive electrode current collector, for example, a conductive metal such as aluminum, an aluminum alloy, nickel, or stainless steel. In this case, the positive electrode current collecting unit 50 has a substantially L-like shape. The positive electrode current collecting unit 50 includes a positive electrode first current collecting unit and a positive electrode second current collecting unit. The positive electrode first current collecting unit extends along an inner surface of the lid body 14 and is connected to the positive electrode terminal 30. The positive electrode second current collecting unit extends along the short side wall 12c of the case main body 12 and is connected to the positive electrode tab 23.

The negative electrode current collecting unit 60 constitutes a conductive path that electrically connects the negative electrode tab 25 and the negative electrode terminal 40. The negative electrode current collecting unit 60 may be formed of the same metal species as the negative electrode current collector, for example, a conductive metal such as copper, a copper alloy, nickel, or stainless steel. In this case, the negative electrode current collecting unit 60 has a substantially L-like shape. The negative electrode current collecting unit 60 includes a negative electrode first current collecting unit and a negative electrode second current collecting unit. The negative electrode first current collecting unit extends along the inner surface of the lid body 14 and is connected to the negative electrode terminal 40. The negative electrode second current collecting unit extends along the short side wall 12c of the case main body 12 and is connected to the negative electrode tab 25.

The positive electrode internal insulating member 70 is provided between the inner surface of the lid body 14 and the electrode body 20. The positive electrode internal insulating member 70 is a member that insulates between the lid body 14 and the positive electrode current collecting unit 50 (in detail, the positive electrode first current collecting unit) inside the exterior body 10. For example, the positive electrode internal insulating member 70 is made of a resin material that has resistance against the electrolyte solution to be used and an electrical insulating property and that is capable of elastic deformation. The positive electrode internal insulating member 70 is favorably made of a polyolefin-based resin such as polypropylene (PP), a fluorinated resin such as tetrafluoroethylene-perfluoroalkoxy ethylene copolymer (PFA), or polyphenylene sulfide (PPS), for example. The positive electrode internal insulating member 70 is one example of an insulating member.

As shown in FIG. 2, the positive electrode internal insulating member 70 in this case includes a base part 70a and a protrusion part 70b. In this case, the base part 70a and the protrusion part 70b are integrally molded. The base part 70a is disposed between the lid body 14 and the positive electrode first current collecting unit and extends along the inner surface of the lid body 14. The protrusion part 70b protrudes to a side of the electrode body 20 compared to the base part 70a. As shown in FIG. 2, in the long side direction Y, the protrusion part 70b is provided on a side of the center of the lid body 14 compared to the base part 70a. In the structure of the battery 100 including the positive electrode internal insulating member 70 with the protrusion part 70b, the clearance is secured between the lid body 14 and the electrode body 20.

As shown in FIG. 2, the negative electrode internal insulating member 80 is disposed symmetrical to the positive electrode internal insulating member 70 with respect to the long side direction Y of the electrode body 20. A specific structure of the negative electrode internal insulating member 80 may be similar to that of the positive electrode internal insulating member 70. The negative electrode internal insulating member 80 is a member that insulates between the lid body 14 and the negative electrode current collecting unit 60 (in detail, the negative electrode first current collecting unit) inside the exterior body 10. In this case, similarly to the positive electrode internal insulating member 70, the negative electrode internal insulating member 80 includes a base part 80a disposed between the lid body 14 and the negative electrode first current collecting unit, and a protrusion part 80b that protrudes to a side of the electrode body 20 compared to the base part 80a.

<Processing Method for Battery 100>

A processing method in the present embodiment is a method for opening the exterior body 10 of the battery 100 that is collected from a market. Note that the collected battery 100 may be in an unused state or a used state. The collected battery 100 may be in a state where the battery cannot be used due to overcharge, overdischarge, or the like and discharge is impossible.

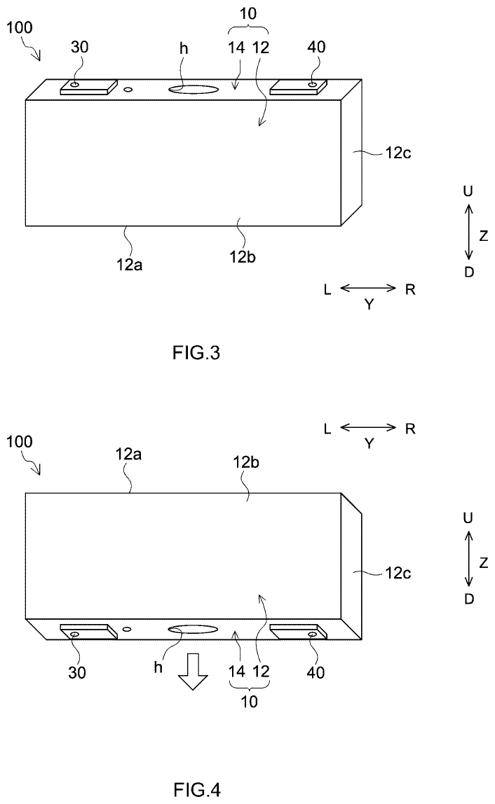

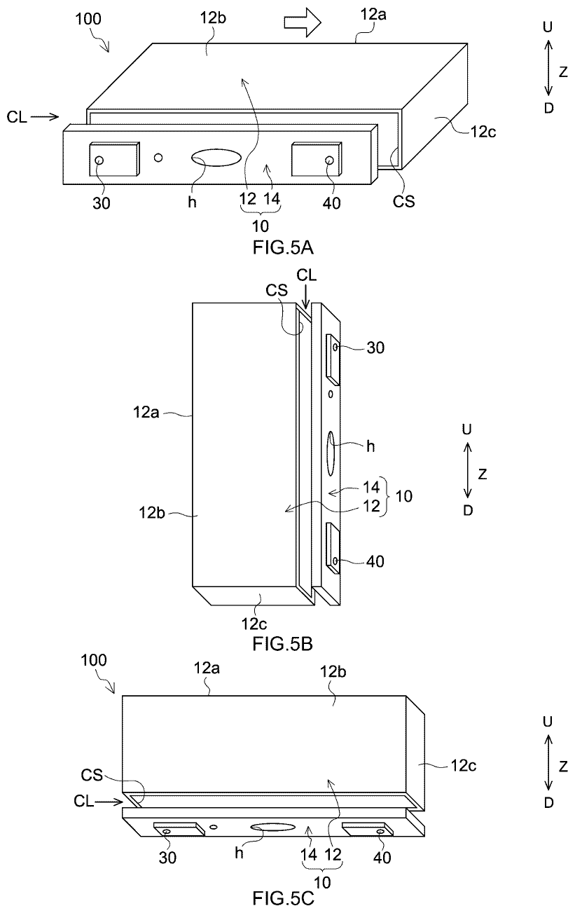

The processing method in the present embodiment includes a voltage checking step (step S1), a discharge processing step (step S2), a hole working step (step S3), a deactivation processing step (step S4), a drainage step (step S5), and a cutting step (step S6) in this order. In addition, another step can be included at any stage. FIG. 3 is a schematic view of the battery 100 in the hole working step (step S3), FIG. 4 is a schematic view of the battery 100 in the drainage step (step S5), and FIGS. 5A to 5C are schematic views of the battery 100 in the cutting step (step S6).

In the voltage checking step (step S1), the collected battery 100 is connected to a charging and discharging device and the voltage (voltage at collection) is checked. Note that in the present step, the battery 100 (in detail, the exterior body 10) is typically in a normal posture in which the lid body 14 is positioned directly above in the vertical direction Z, and the long side walls 12b and short side walls 12c extend along the vertical direction Z. However, the battery 100 may be, for example, in a fallen posture to be described below other than the normal posture.

In many case, the collected battery 100 has a voltage. If the collected battery 100 has the voltage, a discharge process is preferably performed before the cutting step (step S6). Thus, the process advances to step S2. However, when the collected battery 100 does not have the voltage, the discharge is impossible, or the like, the discharge process can be omitted. Thus, step S2 may be omitted and the process may advance to step S3, or steps S2 to S5 may be omitted and the process may advance to step S6.

In the discharge processing step (step S2), the battery 100 is compulsively discharged to reduce the voltage of the battery 100. Thus, the safety in the operations in the following steps can be increased. In detail, the risks of the occurrence of a large quantity of gas in the deactivation processing step (step S4) and the ignition due to short-circuiting between the positive and negative electrodes in the cutting step (step S6) can be reduced. Note that in the present step, the battery 100 (in detail, the exterior body 10) is typically in the normal posture. However, the battery 100 may be, for example, in the fallen posture to be described below other than the normal posture.

The discharge process can be performed in a manner similar to the conventional one. In many cases, the collected batteries 100 vary in state of charge (SOC). Thus, a discharge condition in the present step such as a discharge rate and an attainment voltage at constant current discharge (CC discharge) and a holding voltage and a holding time at constant voltage discharge (CV discharge) is preferably adjusted as appropriate depending on the voltage of the battery 100 at the collection. From the viewpoint of increasing the safety in the operations in the following steps, it is preferable that a residual voltage be made as low as possible. Therefore, the discharge process is preferably performed until the residual voltage of the battery 100 becomes about 0.5 V or less, for example, substantially 0 V. Then, the process advances to step S3.

As shown in FIG. 3, in the hole working step (step S3), a hole h through which a liquid flows into the exterior body 10 is made at the exterior body 10. The hole h has the size such that the liquid typically can flow into the exterior body 10 but the electrode body 20 cannot be extracted. The number of holes h may be one, or two or more (plural). However, if the collected battery 100 already has a hole (for example, the gas discharge valve 17 has been fractured) and the like, the present step may be omitted and the process may advance to step S4.

The hole h can be made at the exterior body 10 by a tool such as a drill or a gimlet. An atmosphere when the hole h is made is preferably an inert gas atmosphere. Note that in the present step, the battery 100 (in detail, the exterior body 10) is typically in the normal posture. However, the battery 100 may be, for example, in the fallen posture to be described below other than the normal posture.

Although not particularly limited, when the battery 100 includes the liquid electrolyte (nonaqueous electrolyte solution), it is preferable that the hole h be made at a part that is positioned above the exterior body 10 in the vertical direction Z. For example, if the battery 100 (in detail, the exterior body 10) is in the normal posture, it is preferable that the hole h be made at the lid body 14. Thus, it is possible to prevent the nonaqueous electrolyte solution from spilling from the exterior body 10 when the hole h is made.

It is preferable that the hole h be made at a part apart from the positive electrode terminal 30 and the negative electrode terminal 40, for example, a position of the gas discharge valve 17 provided to the lid body 14 as shown in FIG. 3. As described above, the gas discharge valve 17 is configured to fracture when the pressure inside the exterior body 10 reaches the predetermined value or more. Thus, the gas discharge valve 17 is the weakest part of the exterior body 10 where the hole h can be made easily. Therefore, the hole h can be made with a relatively small power. As shown in FIG. 3, the hole h may be larger than the gas discharge valve 17, for example. The part where the hole h is made may be another part of the exterior body 10, for example, a part of the lid body 14 other than the gas discharge valve 17, and the bottom wall 12a, the long side wall 12b, and the short side wall 12c of the case main body 12. Then, the process advances to step S4.

In the deactivation processing step (step S4), a conductive liquid (deactivation processing liquid) such as a saline solution is fed into the exterior body 10 from the hole h of the exterior body 10, so that the battery 100 is deactivated. As the method of feeding the deactivation processing liquid into the exterior body 10, the deactivation processing liquid may be injected into the exterior body 10 from the hole h or the exterior body 10 itself may be immersed in the deactivation processing liquid, for example. Note that in the present step, the battery 100 (in detail, the exterior body 10) is typically in the normal posture. However, when the exterior body 10 itself is immersed in the deactivation processing liquid, for example, the battery 100 may be, for example, in the fallen posture to be described below other than the normal posture.

The deactivation process (typically, saline solution process) may be performed in a manner similar to the conventional one. A deactivation processing condition such as a processing time, the concentration of a processing agent (salt (sodium chloride) or the like), or the electric conductivity of the deactivation processing liquid may be adjusted as appropriate depending on the residual voltage of the battery 100. Thus, the battery 100 can be completely discharged and deactivated. Then, the process advances to step S5.

In the drainage step (step S5), the deactivation processing liquid that has flowed into the exterior body 10 in the deactivation processing step (step S4) is drained. In the present embodiment, as shown in FIG. 4, for example, the exterior body 10 is set to an inversion posture, that is, the battery 100 (in detail, the exterior body 10) is inverted so that the hole h or the lid body 14 will face directly downward in the vertical direction Z. Thus, as shown by an arrow in FIG. 4, the deactivation processing liquid is drained from the hole h quickly and the present step can be performed efficiently in a short time. However, the battery 100 may be, for example, in the fallen posture to be described below other than the inversion posture depending on the position of the hole h or the like. Then, the process advances to step S6.

In the cutting step (step S6), the exterior body 10 is cut along the opening 12h. In the present embodiment at this time, the battery 100 (in detail, the exterior body 10) is in a posture other than the normal posture. Note that in the present specification, “posture other than normal posture” is a concept encompassing, except for the posture in which the lid body 14 faces directly upward in the vertical direction Z, an upward inclined posture (not shown) in which the lid body 14 faces upward obliquely in the vertical direction Z, the fallen posture (see FIGS. 5A and 5B) in which the lid body 14 faces in a horizontal direction, a downward inclined posture (not shown) in which the lid body 14 faces downward obliquely in the vertical direction Z, and the inversion posture (see FIG. 5C) in which the lid body 14 faces directly downward in the vertical direction Z. Thus, compared to a case where the present step is performed when the battery 100 is in the normal posture, mixing of a foreign substance such as cutting trash to the inside of the case main body 12 from a cutting opening surface CS can be suppressed relatively. In particular, the battery 100 (in detail, the exterior body 10) is preferably in any one of the fallen posture, the downward inclined posture, and the inversion posture. Thus, the mixing of a foreign substance can be relatively suppressed at a high level compared to the case where the battery 100 (in detail, the exterior body 10) is in the upward inclined posture.

In a preferred aspect, as shown in FIG. 5A, the battery 100 (in detail, the exterior body 10) is set to a first fallen posture in which the pair of long side walls 12b are positioned above and below in the vertical direction Z and the lid body 14 faces in the horizontal direction. In another preferred aspect, as shown in FIG. 5B, the battery 100 (in detail, the exterior body 10) is set to a second fallen posture in which the pair of short side walls 12c are positioned above and below in the vertical direction Z and the lid body 14 faces in the horizontal direction. In this case, since the cutting opening surface CS along the opening 12h faces in the horizontal direction, a foreign substance such as cutting trash drops in the vertical direction and the mixing of a foreign substance to the inside of the case main body 12 from the cutting opening surface CS can be suppressed at a higher level.

In still another preferred aspect, as shown in FIG. 5C, the battery 100 (in detail, the exterior body 10) is set to the inversion posture in which the lid body 14 faces directly downward in the vertical direction Z. In this case, since the cutting opening surface CS along the opening 12h faces directly downward in the vertical direction Z, a foreign substance such as cutting trash drops in the vertical direction and the mixing of a foreign substance to the inside of the case main body 12 from the cutting opening surface CS can be suppressed at a much higher level. Note that if the inversion posture is employed in the drainage step (step S5), the process can directly advance to the present step and operation efficiency can be improved.

The operation of cutting the exterior body 10 can be performed using a conventionally known processing machine. In particular, a processing machine including a ceramic blade or a water jet cutting machine is preferably used. Thus, it is possible to prevent the conductive member (for example, the positive electrode current collector, the negative electrode current collector, the positive electrode current collecting unit 50, or the negative electrode current collecting unit 60) from electrically connecting with the lid body 14, that is, the occurrence of a spark due to short-circuiting can be prevented. Therefore, the safety of the operation can be increased. Moreover, when the water jet cutting machine is used, the exterior body 10 can be cut without a thermal effect, and a cooling effect can be obtained, that is, the risk of the ignition can be suppressed.

Note that in the present specification, “water jet cutting machine” refers to a general cutting device that cuts the exterior body 10 using a thin water jet with high speed, high density, and high pressure energy, and refers to a concept encompassing water jet cutting in which cutting is performed by only a fluid such as water, and abrasive jet cutting in which cutting is performed by a fluid such as water with abrasive mixed therein. Note that the fluid used in cutting is typically water, but may be a fluid other than water. As the water jet cutting machine, a conventionally known one may be used. Examples thereof include Abrasive Jet Cutter by Sugino Machine Limited.

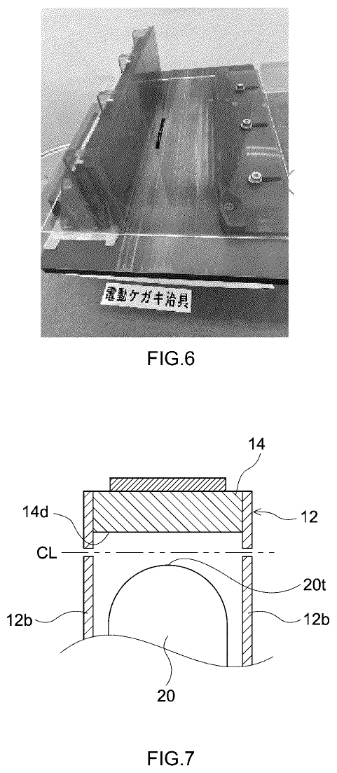

FIG. 6 is a picture of a cutting device according to an example. This cutting device is made by modifying a desktop circular saw board including a cutting blade on the market (for example, K-210 by HOZAN). In this modification, a guide is provided along the cutting blade in order to regulate a cutting position and adjust a protrusion allowance. In this example, the exterior body 10 with the fallen posture (see FIGS. 5A and 5B) is slid along the guide and the pair of long side walls 12b and the pair of short side walls 12c are cut along a cutting line CL. In this case, the exterior body 10 is moved relative to the cutting device, but the cutting blade may be moved relative to the fixed exterior body 10. The position of cutting the exterior body 10 (the position of the cutting line CL) can be adjusted by the distance between the cutting blade and the guide. Thus, the case main body 12 and the lid body 14 can be separated from each other. In many cases, the collected batteries 100 vary in size and structure. However, by using the cutting device including such a guide, the batteries 100 with various sizes and structures can be cut stably by just changing the position of the guide. Therefore, this method is efficient.

Note that the position of cutting the exterior body 10 (the position of the cutting line CL) is preferably a position in which the electrode body 20 will not be damaged. For example, in order to prevent the electrode body 20 from being damaged, connection parts between the electrode body 20, and the positive electrode terminal 30 and the negative electrode terminal 40 (in detail, parts of the positive electrode current collecting unit 50 and the negative electrode current collecting unit 60) are preferably cut. In a preferred aspect, as shown in FIG. 7, a position corresponding to the place between an inner side surface 14d of the lid body 14 and an upper end 20t of the electrode body 20 is set as the cutting line CL and the exterior body 10 is cut. In an example, the exterior body 10 is preferably cut at a position 2 to 4.5 mm from an upper surface of the lid body 14. However, the cutting position is not limited to this example particularly, because the cutting position may vary depending on the size, structure, and the like of the battery 100.

As described above, in the structure of the battery 100 including the blind rivet 16, the clearance exists between the inner side surface 14d of the lid body 14 and the upper end 20t of the electrode body 20. Such a clearance always exists at a fixed position. Thus, by cutting the exterior body 10 (in detail, the case main body 12) at a part of the clearance (space part), the exterior body 10 can be cut without the damage of the electrode body 20 even when the cutting blade penetrates the exterior body 10. Note that whether the battery 100 includes the blind rivet 16 can be determined based on the external appearance of the battery 100. Thus, without extra inspection or the like before cutting, the cutting position (the position of the cutting line CL) in which the electrode body 20 will not be damaged can be determined, which is convenient.

In addition, in the structure of the battery 100 including at least one of the positive electrode internal insulating member 70 with the protrusion part 70b and the negative electrode internal insulating member 80 with the protrusion part 80b, the clearance exists between the inner side surface 14d of the lid body 14 and the upper end 20t of the electrode body 20. Thus, by cutting the exterior body 10 (in detail, the case main body 12) at the part of the clearance (the space part), the exterior body 10 can be cut without the damage of the electrode body 20 even when the cutting blade penetrates the exterior body 10. In this case, for example, after the position of the space part is checked by X-ray inspection or the like, the cutting position (the position of the cutting line CL) in which the electrode body 20 will not be damaged may be determined.

The battery 100 is processed as described above to open the exterior body 10, and thus, the case main body 12 and the lid body 14 can be separated from each other. The case main body 12 can be recycled as aluminum. In addition, the electrode body 20 is extracted from the case main body 12 and separated into a mixture (so-called, black mass) and a current collector, and then, a valuable metal can be collected from the electrode body 20 by a conventionally known method. For example, a rare metal such as lithium (Li) or a transition metal (for example, Ni, Co, and Mn) can be collected.

As described above, the following items are given as specific aspects of the art disclosed herein.
Item 1: The processing method for a battery that includes the exterior body and the electrode body accommodated in the exterior body, the exterior body including: the case main body including the bottom wall, the opening that faces the bottom wall, and the side walls that extend from the bottom wall to the opening; and the lid body that seals the opening of the case main body, and the processing method including the cutting step of, when the posture in which the lid body is positioned directly above in the vertical direction and the side walls extend along the vertical direction is defined as the normal posture, cutting the exterior body in the posture other than the normal posture along the opening.
Item 2: The processing method according to Item 1, in which in the cutting step, the position corresponding to the place between the electrode body and the lid body is cut.
Item 3: The processing method according to Item 1 or 2, in which the lid body includes the penetration hole, and the battery further includes the blind rivet that covers the penetration hole.
Item 4: The processing method according to any one of Items 1 to 3, in which the battery further includes the insulating member that is provided between the electrode body and the lid body, and the insulating member includes the base part that extends along the inner surface of the lid body and the protrusion part that protrudes to the side of the electrode body compared to the base part.
Item 5: The processing method according to any one of Items 1 to 4, in which in the cutting step, the exterior body is set to any one of the fallen posture in which the lid body faces in the horizontal direction, the downward inclined posture in which the lid body faces downward obliquely in the vertical direction, and the inversion posture in which the lid body faces directly downward in the vertical direction.
Item 6: The processing method according to any one of Items 1 to 4, in which in the cutting step, the exterior body is set to the inversion posture in which the lid body faces directly downward in the vertical direction.
Item 7: The processing method according to any one of Items 1 to 4, in which the side walls include the pair of short side walls and the pair of long side walls, and in the cutting step, the exterior body is set to the first fallen posture in which the pair of long side walls are positioned above and below in the vertical direction and the lid body faces in the horizontal direction.
Item 8: The processing method according to any one of Items 1 to 4, in which the side walls include the pair of short side walls and the pair of long side walls, and in the cutting step, the exterior body is set to the second fallen posture in which the pair of short side walls are positioned above and below in the vertical direction and the lid body faces in the horizontal direction.
Item 9: The processing method according to any one of Items 1 to 8, further including the hole working step of making the hole at the exterior body and the deactivation processing step of feeding the deactivation processing liquid into the exterior body in this order, before the cutting step.
Item 10: The processing method according to any one of Items 1 to 9, in which in the cutting step, the exterior body is cut by the water jet cutting machine.

Although the embodiments of the present disclosure have been described above, these embodiments are just examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified aspect, and the other modified aspect can be added to the aforementioned embodiment. Additionally, the technical feature may be deleted as appropriate unless such a feature is described as an essential element.

### REFERENCE SIGNS LIST

10 Exterior body
12 Case main body
14 Lid body
16 Blind rivet
20 Electrode body
30 Positive electrode terminal
40 Negative electrode terminal
70 Positive electrode internal insulating member
70b Protrusion part
80 Negative electrode internal insulating member
80b Protrusion part
100 Battery

What is claimed is:

1. A processing method for a battery that includes an exterior body and an electrode body accommodated in the exterior body,
the exterior body including:
a case main body including a bottom wall, an opening that faces the bottom wall, and side walls that extend from the bottom wall to the opening; and
a lid body that seals the opening of the case main body, and
the processing method comprising a cutting step of, when a posture in which the lid body is positioned directly above in a vertical direction and the side walls extend along the vertical direction is defined as a normal posture, cutting the exterior body in a posture other than the normal posture along the opening.

2. The processing method according to claim 1, wherein in the cutting step, a position corresponding to a place between the electrode body and the lid body is cut.

3. The processing method according to claim 2, wherein
the lid body includes a penetration hole, and
the battery further includes a blind rivet that covers the penetration hole.

4. The processing method according to claim 2, wherein
the battery further includes an insulating member that is provided between the electrode body and the lid body, and
the insulating member includes a base part that extends along an inner surface of the lid body and a protrusion part that protrudes to a side of the electrode body compared to the base part.

5. The processing method according to claim 1, wherein in the cutting step, the exterior body is set to any one of a fallen posture in which the lid body faces in a horizontal direction, a downward inclined posture in which the lid body faces downward obliquely in the vertical direction, and an inversion posture in which the lid body faces directly downward in the vertical direction.

6. The processing method according to claim 1, wherein in the cutting step, the exterior body is set to an inversion posture in which the lid body faces directly downward in the vertical direction.

7. The processing method according to claim 1, wherein
the side walls include a pair of short side walls and a pair of long side walls, and
in the cutting step, the exterior body is set to a first fallen posture in which the pair of long side walls are positioned above and below in the vertical direction and the lid body faces in a horizontal direction.

8. The processing method according to claim 1, wherein
the side walls include a pair of short side walls and a pair of long side walls, and
in the cutting step, the exterior body is set to a second fallen posture in which the pair of short side walls are positioned above and below in the vertical direction and the lid body faces in a horizontal direction.

9. The processing method according to claim 1, further comprising a hole working step of making a hole at the exterior body and a deactivation processing step of feeding a deactivation processing liquid into the exterior body in this order, before the cutting step.

10. The processing method according to claim 1, wherein in the cutting step, the exterior body is cut by a water jet cutting machine.
